(19) United States
(12) Patent Application Publication
(10) Pub. No.: US 2010/0237989 A1
(43) Pub. Date: Sep. 23, 2010

(54) GOODS MANAGEMENT DEVICE AND GOODS MANAGEMENT SYSTEM

(75) Inventors: Fumihiko Ikegami, Kanagawa-ken (JP); Yoshinori Sato, Shizuoka-ken (JP); Akihiro Souma, Shizuoka-ken (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/719,960

(22) Filed: Mar. 9, 2010

(30) Foreign Application Priority Data
Mar. 18, 2009 (JP) 2009-066559

(51) Int. Cl. G06F 7/04

(52) U.S. Cl. 340/5.61

(57) ABSTRACT

According to one embodiment, the goods management device includes a carried out goods detecting portion that receives a reading result from a first wireless tag reader arranged in a depository storing goods attached with a wireless tag, and detects, based on the result, that the goods attached with tag data have been taken away from the depository; a user data receiving portion that receives, as a reading result, both of tag data, unique to a user, carried by the user who is taking away the goods and tag data attached to the goods being taken away from a second wireless tag reader arranged near a door, which is usually locked, of a building or a room in which the depository is installed; and an unlock direction portion that instructs unlocking of the door, only in a case where the tag data of the goods determined by the carried out goods detecting portion to have been taken away matches with the tag data attached to the goods being taken away and received by the user data receiving portion and where the tag data unique to the user belongs to the user who has a proper permission.

### CROSS-REFERENCE TO RELATED APPLICATION

This application is also based upon and claims the benefit of priority from Japanese Patent Application No. 2009-066559, filed on Mar. 18, 2009, the entire contents of which are incorporated herein by reference.

### TECHNICAL FIELD

Exemplary embodiments described herein relate to a goods management device and a goods management system capable of safely managing goods such as a document and a valuable by using a wireless tag and a reader.

### BACKGROUND

Recently, a wireless tag enables easily carrying out goods management and room entrance/exit management, and is used to improve security and inventory management of goods. As the inventory management of goods, Smart Shelf capable of managing merchandizes attached with wireless tags has been developed, and Smart Shelf has been applied to a comprehensive merchandize management system used in factories and stores of a department store and a library system for books in a library.

With regard to security, a system has been developed to permit entrance/exit of a person who brings goods based on wireless tag data and to open or close an electronic lock. A further advanced form of such system is known to manage not only goods but also entrance/exist at the same time. An example of this kind of conventional art is as follows.

For example, Japanese Patent Application Publication No. 2008-7992 discloses an electronic lock open/close system. This electronic lock open/close system causes a reading apparatus (such as a cell-phone) to read a wireless tag fixed to a door and the like in a room. The reading apparatus transmits a pair of an ID (identifier) of a wireless tag and an ID of the tag reading apparatus to an approval data providing server. The approval data server performs authentication based on the two IDs, and determines, e.g., whether an electronic lock can be opened or not.

Meanwhile, Japanese Patent Application Publication No. 2007-2264541 discloses a furniture-linked entrance/exit management system. This furniture-linked entrance/exit management system is arranged with goods identification means that identifies whether there are any goods contained in a piece of furniture. When an unlocking operation of a door in a room is performed while the goods identification means determines that there is not any goods contained, the goods identification means determines that goods are illegally taken away and gives a warning.

However, in the technique disclosed in Japanese Patent Application Publication No. 2008-7992, entrance/exit of the user can be managed, but there is a drawback in that goods taken away with the user cannot be managed. On the other hand, in the technique disclosed in Japanese Patent Application Publication No. 2007-226454, only user authentication is performed when the user exits from the room. Therefore, after management-target goods are taken away from a piece of furniture, it is difficult to determine whether the goods are left in the room or they are taken away from the room. Thus, Japanese Patent Application Publication No. 2007-226454 has a drawback in that the location of the goods cannot be accurately recognized.

### SUMMARY

An object of the present invention is to provide a goods management device and a goods management system that are inexpensive but provide high level of security and can clearly manage the location of goods taken away by a user.

An aspect of the present disclosure relates to a goods management device containing, a carried out goods detecting portion that receives a reading result from a first wireless tag reader arranged in a depository storing goods attached with a wireless tag, and detects, based on the result, that the goods attached with tag data have been taken away from the depository, a user data receiving portion that receives, as a reading result, both of tag data, unique to a user, carried by the user who is taking away the goods and tag data attached to the goods being taken away from a second wireless tag reader arranged near a door, which is usually locked, of a building or a room in which the depository is installed, and an unlock direction portion that instructs unlocking of the door, only in a case where the tag data of the goods determined by the carried out goods detecting portion to have been taken away matches with the tag data attached to the goods being taken away and received by the user data receiving portion and where the tag data unique to the user belongs to the user who has a proper permission.

Another aspect of the present disclosure relates to a goods management device containing, a carried out goods detecting portion that receives a reading result from a first wireless tag reader arranged in a depository storing goods attached with a wireless tag, and determines, based on the result, that the goods attached with the tag data have been taken away from the depository, a user data receiving portion that receives, from a portable terminal having a reading function of a tag data, tag data of a wireless tag fixed near a door, which is usually locked, of a building or a room in which the depository is installed, tag data attached to the goods taken away, and an identifier of the portable terminal, and an unlock direction portion that instructs unlocking of the door, only in a case where the tag data of the goods determined by the carried out goods detecting portion to have been taken away matches with the wireless tag data attached to the goods being taken away and received by the user data receiving portion and where the user of the portable terminal is determined to have a proper permission based on the identifier of the portable terminal.

Further an aspect of the present disclosure relates to a goods management system containing, a depository storing goods attached with a wireless tag, a first wireless tag reader arranged in the depository so as to detect an ID of the goods stored in the depository, a second wireless tag reader arranged near a door, which is usually locked, of a building or a room in which the depository is installed, and a goods management device including, a carried out goods detecting portion that determines that goods having an ID have been taken away, in a case where the ID of the goods was detected in the past by the first wireless tag reader but is not no longer detected recently, a user data receiving portion that causes the second wireless tag reader to read both of tag data, unique to a user, carried by the user who is taking away the goods from the depository and the wireless tag data attached to the goods being taken away, and receives the reading result, and an unlock direction portion that instructs unlocking of the door, only in a case where the tag data of the goods determined by the carried out goods detecting portion to have been taken away matches with the tag data attached to the goods being taken away and received by the user data receiving portion and where the tag data unique to the user belongs to the user who has a proper permission.

### BRIEF DESCRIPTION OF THE DRAWINGS

FIG. 1 is a configuration diagram showing a goods management system using a wireless tag reader according to a first embodiment of the present invention;

FIG. 2 is a block diagram showing a goods management server according to the first embodiment and a second embodiment of the present invention;

FIG. 3 is a configuration diagram showing a goods management system using a wireless tag reader according to the second embodiment of the present invention;

FIG. 4 is a configuration diagram showing a goods management system using a wireless tag reader according to a third embodiment of the present invention; and

FIG. 5 is a block diagram showing a goods management server according to the third embodiment of the present invention.

### DETAILED DESCRIPTION

Embodiments according to the present invention will be hereinafter described in detail with reference to the drawings.

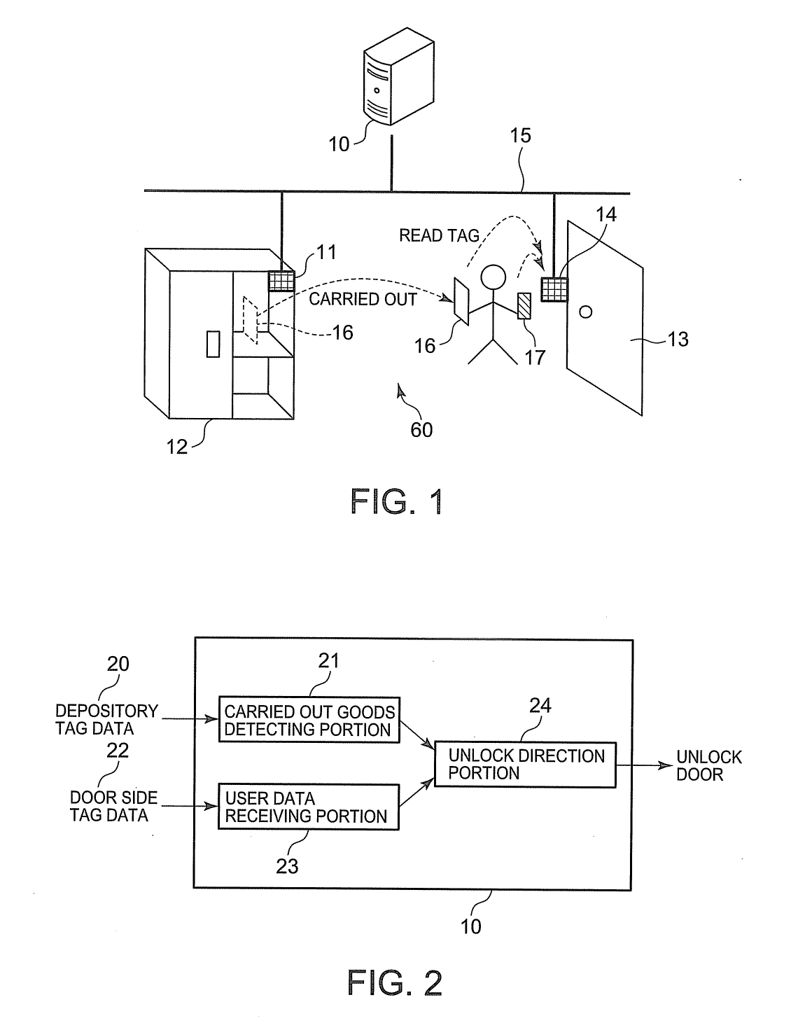

FIG. 1 is a configuration diagram showing a goods management system using a wireless tag reader according to a first embodiment of the present invention. FIG. 2 is a block diagram showing an internal configuration of a goods management server.

The goods management system includes a goods management server 10, a depository 12 attached with a wireless tag reader 11, and a wireless tag reader 14 installed near a door 13, which is usually locked, of a building or a room 60 in which the depository 12 is installed. The goods management server 10, the depository 12, and the wireless tag reader 14 are connected via a network 15 such as LAN (Local Area Network). The wireless tag reader 14 beside the door 13 can read IDs (identifiers) of a cell-phone 17 and an employee ID card carried by the user and goods 16 taken away by the user.

The goods management server 10 is constituted by a server on which an application achieving the present invention is executed.

All the goods 16 present in the depository 12 are attached with tags. The goods management server 10 includes a carried out goods detecting portion 21, a user data receiving portion 23, and an unlock direction portion 24.

The carried out goods detecting portion 21 receives tag data of the goods attached with the tags (depository tag data 20), and detects whether there are any goods currently being taken away. The user data receiving portion 23 receives IDs (door-side tag data 22) read by the wireless tag reader 14 beside the door 13 through which the user enters to or exits from the building or the room in which the depository 12 is installed. The unlock direction portion 24 determines to open the door 13 based on data given by the carried out goods detecting portion 21 and the user data receiving portion 23. The data read by the wireless tag reader 14 beside the door 13 is not limited to the tag IDs attached to the goods 16, but may be the ID of the cell-phone 17 or the employee ID card carried by the user.

The wireless tag reader 11 installed in the depository 12 periodically searches a neighboring area by means of radio wave to detect the tag attached to each of the goods 16. The wireless tag reader 11 transmits the ID of the tag to the goods management server 10. In a case where a certain tag was detected in the past but is now no longer detected by a recent search, the carried out goods detecting portion 21 in the goods management server 10 determines that the goods 16 attached with the not-detected ID are taken away. The goods management server 10 memorizes the ID of the goods being taken away.

The user takes the goods 16 from a shelf in the depository 12, walks up to the door 13, and then requests unlocking of the door by holding, over the wireless tag reader 14 beside the door, not only the goods 16 but also the cell-phone 17 or the employee ID card of the user attached with the wireless tag. At this moment, the ID of the goods 16 and the ID of the cell-phone 17 or the employee ID card of the user are transmitted from the wireless tag reader 14 beside the door 13 to the user data receiving portion 23 of the goods management server 10.

The user data receiving portion 23 gives the above two IDs to the unlock direction portion 24, and requests the unlock direction portion 24 to determine whether the door can be unlocked. When the unlock direction portion 24 determines that the ID of the goods memorized in the carried out goods detecting portion 21 matches with the ID of the goods 16 received from the user data receiving portion 23, and determines that the user has a permission to take away the good, the unlock direction portion 24 transmits an unlock instruction to the door 13.

The above goods management system according to the first embodiment performs not only the user authentication of the user exiting from the room but also the confirmation of the goods being taken away from the room when the user exits from the room. Therefore, the above goods management system can prevent the user from exiting from the room with the goods being left in the room. In addition, the above goods management system can reliably keep track of who took away the good, what was taken away, and when the goods were taken away.

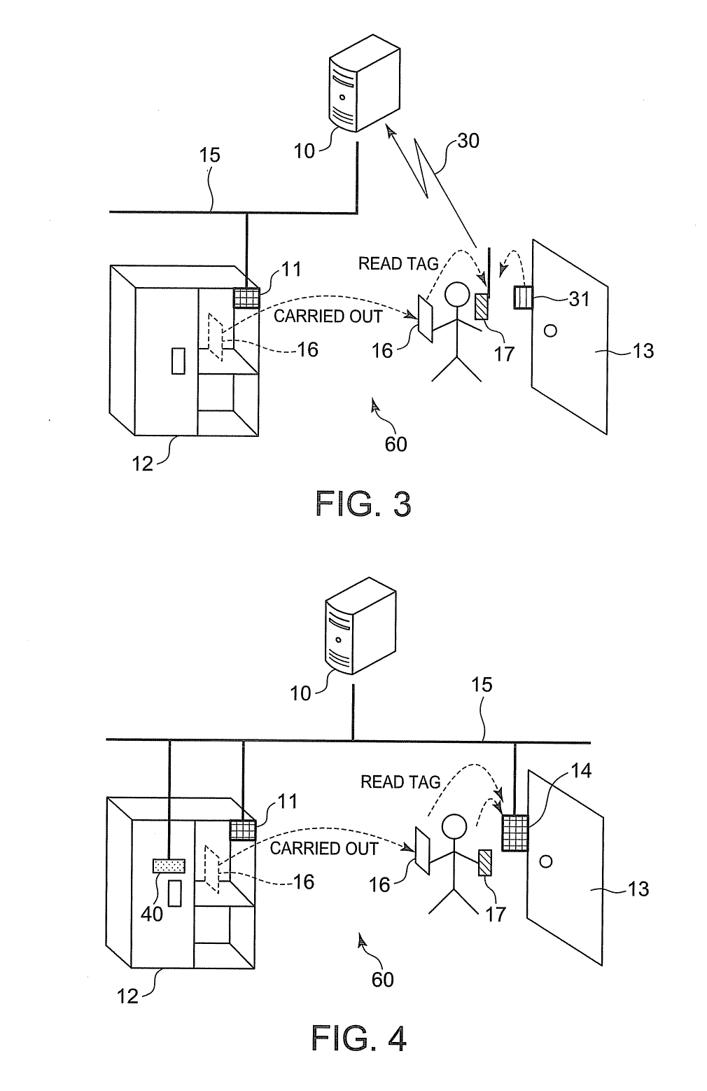

FIG. 3 shows a goods management system using a wireless tag reader according to a second embodiment of the present invention. The internal configuration of the goods management server 10 is the same as that shown in FIG. 2, and accordingly, the description will be made with reference to FIG. 2.

The goods management system includes the goods management server 10 and the depository 12 attached with the wireless tag reader 11. The goods management server 10 and the depository 12 are connected via the network 15 such as LAN (Local Area Network). The cell-phone 17 carried by the user is connected to a wireless network 30 and the like. The cell-phone 17 has a function of a tag reader for wireless tags.

The wireless tag reader 11 installed in the depository 12 periodically searches a neighboring area by means of radio wave to detect the tag attached to each of the goods 16. The wireless tag reader 11 transmits the ID of the tag to the goods management server 10. In a case where a certain tag was detected in the past but is now no longer detected by a recent search, the carried out goods detecting portion 21 in the goods management server 10 determines that the goods 16 attached with the not-detected ID are taken away. The carried out goods detecting portion 21 memorizes the ID of the goods 16.

When the user takes the goods 16 from a shelf in the depository 12, the user walks up to the door 13. The user uses the user's cell-phone 17 having the wireless tag reading function to read the tag attached to the goods 16 and a tag 31 fixed on the door 13 or a wall near the door 13. The user transmits the IDs of these tags to the user data receiving portion 23 of the goods management server 10 by using functions such as a form transmission and a mail transmission on a browser of the cell-phone 17. At this moment, not only the ID of the tag of the goods 16 but also the user ID of the user read from the cell-phone 17 are transmitted together.

When the user data receiving portion 23 receives from the cell-phone 17 the ID of the tag attached to the goods 16, the ID of the tag 31 attached to the door 13 or beside the door, and the user ID of the cell-phone 17, the user data receiving portion 23 gives the above information to the unlock direction portion 24, and requests the unlock direction portion 24 to determine whether the door can be unlocked. When the unlock direction portion 24 determines that the ID of the goods memorized in the carried out goods detecting portion 21 matches with the ID of the goods received from the user data receiving portion 23, and determines that the user has a permission to take away the good, the unlock direction portion 24 transmits an unlock instruction to the door 13 corresponding to the ID of the tag 31 attached to the door 13 or beside the door 13.

In the above goods management system according to the second embodiment, the wireless tag 31 is fixed to the door of the building or the room, and the wireless tag 31 is read by the cell-phone 17 carried by the user. Therefore, it is not necessary to install an expensive wireless tag reader to each door to read the tag 31, and the cost can be reduced.

The cell-phone described in the second embodiment is not limited to a cell-phone but may be a portable terminal having both of the wireless tag reading function and the wireless communication function and having an ID that can uniquely identify the portable terminal itself.

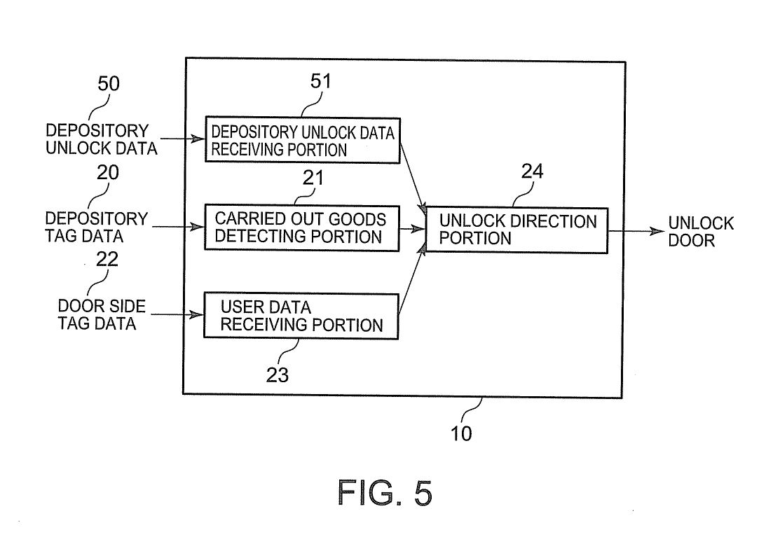

FIG. 4 is a configuration diagram showing a goods management system using a wireless tag reader according to a third embodiment of the present invention. FIG. 5 is a block diagram showing a goods management server according to the third embodiment of the present invention.

FIG. 4 is different from FIG. 1 in that an unlock device 40 is arranged in the depository 12. Further, the goods management server 10 can receive unlock data of the depository 12 via the network 15 such as LAN.

In FIG. 5, a depository unlock data receiving portion 51 is added to receive unlock data 50 of the depository 12.

The configuration of this embodiment is substantially the same as that of the first embodiment in terms of the goods management system. However, the following operation is different. Before the user takes the goods 16, the user causes the unlock device 40 of the depository 12 to read the user ID of the user stored in the cell-phone 17 or the employee ID card carried by the user. Then, the unlock device 40 transmits this user ID to the goods management server 10. In addition, the goods management server 10 also inspects whether the user ID used to unlock the depository 12 matches with the user ID read at the door 13.

In the above third embodiment, the user's identify is checked when the user takes the goods away from the depository 12, and it is inspected whether the above-identified user who takes away the goods matches with the user who exits from the room 60. Therefore, a higher level of security can be achieved.

In the above explanation, the unlock device 40 is added to the depository 12 of the first embodiment. Likewise, the unlock device 40 may be added to the depository 12 of the second embodiment.

As hereinabove described, according to the goods management system linked to the wireless tag reader according to the present embodiment, not only the management of the goods but also the management of the person who takes away the goods are performed at the same time. Therefore, inexpensive but highly secure system accurately recognizing the location of goods can be provided.

The present invention is not limited to the above embodiments, but may be carried out upon modifying constituent elements without deviating from the gist of the present invention. Various inventions can be formed by an appropriate combination of the plurality of constituent elements disclosed in the above embodiments. For example, several constituent elements may be deleted from all of the constituent elements shown in the embodiments. Further, constituent elements in different embodiments may be appropriately combined.

What is claimed is:

1. A goods management device comprising:
a carried out goods detecting portion that receives a reading result from a first wireless tag reader arranged in a depository storing goods attached with a wireless tag, and detects, based on the result, that the goods attached with tag data has been taken away from the depository;
a user data receiving portion that receives, as a reading result, both of tag data, unique to a user, carried by the user who is taking away the goods and tag data attached to the goods being taken away from a second wireless tag reader arranged near a door, which is usually locked, of a building or a room in which the depository is installed; and
an unlock direction portion that instructs unlocking of the door, only in a case where the tag data of the goods determined by the carried out goods detecting portion to have been taken away matches with the tag data attached to the goods being taken away and received by the user data receiving portion and where the tag data unique to the user belongs to the user who has a proper permission.

2. The device according to claim 1 further comprising:
a depository unlock data receiving portion that receives user data of a user who performs unlocking operation from an unlocking device that unlocks the door of the depository according to the proper user data,
wherein the user data obtained by the depository unlock data receiving portion and the user data obtained by the user data receiving portion are used to determine whether the unlock direction portion can be performed or not.

3. A goods management device comprising:
a carried out goods detecting portion that receives a reading result from a first wireless tag reader arranged in a depository storing goods attached with a wireless tag, and determines, based on the result, that the goods attached with the tag data has been taken away from the depository;
a user data receiving portion that receives, from a portable terminal having a reading function of a tag data, tag data of a wireless tag fixed near a door, which is usually locked, of a building or a room in which the depository is installed, tag data attached to the goods taken away, and an identifier of the portable terminal; and
an unlock direction portion that instructs unlocking of the door, only in a case where the tag data of the goods determined by the carried out goods detecting portion to have been taken away matches with the wireless tag data attached to the goods being taken away and received by the user data receiving portion and where the user of the portable terminal is determined to have a proper permission based on the identifier of the portable terminal.

4. The device according to claim 3 further comprising:
a depository unlock data receiving portion that receives user data of a user who performs unlocking operation from an unlocking device that unlocks the door of the depository according to the proper user data,
wherein the user data obtained by the depository unlock data receiving portion and the user data obtained by the user data receiving portion are used to determine whether the unlock direction portion can be performed or not.

5. The device according to claim 3, wherein the portable terminal includes a cell-phone that has the reading function of the wireless tag and a wireless communication function and has an ID uniquely identifying the cell-phone itself.

6. A goods management system comprising:
a depository storing goods attached with a wireless tag;
a first wireless tag reader arranged in the depository so as to detect an ID of the goods stored in the depository;
a second wireless tag reader arranged near a door, which is usually locked, of a building or a room in which the depository is installed; and
a goods management device including:
a carried out goods detecting portion that determines that goods having an ID have been taken away, in a case where the ID of the goods was detected in the past by the first wireless tag reader but is not no longer detected recently;
a user data receiving portion that causes the second wireless tag reader to read both of tag data, unique to a user, carried by the user who is taking away the goods from the depository and the wireless tag data attached to the goods being taken away, and receives the reading result; and
an unlock direction portion that instructs unlocking of the door, only in a case where the tag data of the goods determined by the carried out goods detecting portion to have been taken away matches with the tag data attached to the goods being taken away and received by the user data receiving portion and where the tag data unique to the user belongs to the user who has a proper permission.

7. The system according to claim 6, wherein the goods management device further includes:
a depository unlock data receiving portion that receives user data of a user who performs unlocking operation from an unlocking device that unlocks the door of the depository according to the proper user data,
wherein the user data obtained by the depository unlock data receiving portion and the user data obtained by the user data receiving portion are used to determine whether the unlock direction portion can be performed or not.

8. The system according to claim 6 further comprising:
a network in which the first wireless tag reader, the second wireless tag reader, and the goods management device are connected.
